(19) United States
(12) Patent Application Publication
(10) Pub. No.: US 2013/0337364 A1
(43) Pub. Date: Dec. 19, 2013

(54) FUEL CELL ARRANGEMENT WITH A FUEL CELL STACK DEFORMABLE DURING OPERATION

(71) Applicants: Uwe Burmeister, Muenchen (DE); Jahann Huber, Finsing (DE); Anton Trenkler, Ebersberg (DE); Wolfgang Wagner, Neubiberg (DE)

(72) Inventors: Uwe Burmeister, Muenchen (DE); Jahann Huber, Finsing (DE); Anton Trenkler, Ebersberg (DE); Wolfgang Wagner, Neubiberg (DE)

(73) Assignee: FRAUNHOFER-GESELLSCHAFT ZUR FORDERUNG, Muenchen (DE)

(21) Appl. No.: 13/988,300

(22) PCT Filed: Nov. 11, 2011
(86) PCT No.: PCT/EP11/05667

§ 371 Date: Aug. 29, 2013

(30) Foreign Application Priority Data
Nov. 17, 2010 (DE) 10 2010 051 753.4

(51) Int. Cl. H01M 8/24

(52) U.S. Cl. CPC H01M 8/247
USPC 429/469; 429/470

(57) ABSTRACT

The present invention relates to fuel cell arrangement having at least one fuel cell stack which has a first end plate, a second end plate and numerous fuel cells which each comprise an anode, a cathode and an electrolyte arranged between the anode and the cathode, wherein the fuel cells are arranged along a longitudinal axis of the fuel cell stack between the first and the second end plates, a supporting structure in which the fuel cell stack is arranged, wherein the first end plate of the fuel cell stack is, if appropriate, permanently connected to the supporting structure. The fuel cell arrangement according to the invention is characterized in that at least one bearing means which is different from the first end plate which is, if appropriate, permanently connected to the supporting structure is provided for absorbing transverse forces acting on the fuel cell stack in the transverse direction with respect to the longitudinal axis of the stack.

The present invention relates to a fuel cell arrangement with a fuel cell stack, which is deformable during operation. In particular, the invention relates to the fixation of a fuel cell stack, which is deformable during operation, in a support structure, for example in a housing surrounding the fuel cell stack. Here, in the present context the term “fixation” shall particularly be understood as the prevention of any movements of the stiff body in reference to the support structure.

In order to generate electric energy via fuel cells usually a larger number of fuel cells is arranged in the form of a stack along a longitudinal axis, with the fuel cells each showing an anode, a cathode, and an electrolyte arranged therebetween. The individual fuel cells are each separated from each other by bipolar plates and contacted electrically. In the longitudinal direction the fuel cell stack is limited by a first terminal plate at the beginning of the stack and a second terminal plate at the end of the stack. Power collectors are respectively provided at the anodes and cathodes serving on the one hand to electrically contact the anodes and/or cathodes and on the other hand to guide reaction gases past them. Sealing elements are respectively provided in the edge region of the anode, the cathode, and the electrolyte matrix, which form a lateral seal of the fuel cells and thus the fuel cell stack against any anode or cathode gas leaking out.

Different fuel cell types are known from prior art, such as polymer electrolyte fuel cells, solid oxide fuel cells, or molten carbonate fuel cells.

In a molten carbonate fuel cell the electrolyte material typically comprises binary or ternary molten alkali carbonate (for example molten mixtures of lithium and potassium carbonate), which are bonded in a porous matrix. During operation molten carbonate fuel cells typically reach operating temperatures of approx. 650° C. Here, at the anode side a reaction occurs of hydrogen and carbonate ions into water and carbon dioxide with the release of electrons. At the cathode side oxygen reacts with carbon dioxide into carbonate ions with the absorption of electrons. Here, heat is released. The molten alkali carbonate used here as the electrolyte yields on the one hand the carbonate ions required for the anode part of the reaction and on the other hand absorbs the carbonate ions developing during the cathode part of the reaction. In practice, usually an energy carrier comprising hydrocarbons and water is supplied to the anode side. Suitable energy carriers comprising hydrocarbons are for example methane, originating from natural gas or biogas, among other sources. By an internal reformation the hydrogen required for the anode part of the reaction is yielded from the mixture supplied. The anode exhaust is mixed with additionally supplied air and subsequently oxidized in a catalytic fashion to remove any components potentially still present. The gaseous mixture developing now comprises carbon dioxide and oxygen, thus particularly the gases required for the cathode part of the reaction, so that the anode exhaust after the supply of fresh air and a catalytic oxidation can be directly fed to the cathode part of the cell.

The hot exhaust emitted at the cathode output is free from hazardous substances and can be thermally processed. The electric efficiency of the molten carbonate fuel cell already reaches 45 to 50% and when the released heat is utilized here a total efficiency of approx. 90% can be yielded in the overall process.

The applicant has been able to integrate the fuel cell stack and all system components operating at high temperatures in a common, gas-tight protective housing. This way, on the one hand, the efficiency of the equipment is improved and, on the other hand, an arrangement could be realized, in which the cathode gas flow can freely circulate inside the protective housing and the anode exhaust flow can freely be introduced into the circulating cathode gas flow. The known fuel cell arrangements of the applicant are explained in greater detail for example in the international patent applications WO 96/02951 A1 and WO 96/20506 A1 and in the German patent application DE 195 48 297 A1.

Molten carbonate fuel cell stacks, but also other fuel cells designed for a higher performance range beyond 100 kW, such as solid oxide fuel cells, are subject to considerable deformations during operation due to internal forces caused by temperature profiles in the stack or by chemical reactions. In order to allow these deformations the above-described molten carbonate fuel cells of the applicant are supported, for example, on a support frame in a housing such that the terminal plates are pre-stressed in reference to each other, but simultaneously certain movements of the stack are ensured in the longitudinal and lateral directions. Additionally, external forces may impact the fuel cell stack, for example during ₜhe transportation of the fuel cell to a stationary place of application or during a mobile use of the fuel cell, for example on ships, but also in the stationary use, for example due to earthquakes. Thus it is advantageous for such applications to fixate the fuel cell stack inside a support structure, for example a housing or a carrier surrounded by a housing. The fastening must here prevent movements and deformations of the stack caused by external forces, such as ship movements, but simultaneously allow certain deformations of the stack, for example an extension, shrinkage, or bending due to internal forces. It is known for example to arrange fuel cell stacks vertically in a housing and here to fixate the lower terminal plate of the stack at said housing. Such an arrangement is only suitable for stationary operation or for stacks with a low height, because here external lateral forces can only be compensated by the friction between the individual cells. Additionally it is known to support fuel cell stacks in a horizontal fashion, and here to fixate one of the two terminal plates of the stack at a carrier. The stack may here rest over its entire length on a carrier, however it must be mobile in the longitudinal and the lateral direction in reference to the axis of the stack due to deformations caused by internal forces so that here, too, the compensation of external forces is limited.

The present invention is therefore based on the technical problem to provide a fuel cell arrangement, in which the fuel cell stack is fixated in a support structure such that on the one hand deformations are possible caused by internal forces but simultaneously forces impacting from the outside can be compensated by the support structure so that no excessive stack movement develops, which could damage the fuel cell stack.

This technical problem is attained in a fuel cell arrangement according to claim 1. Advantageous further developments of the invention are the objective of the dependent claims.

Accordingly, the invention relates to a fuel cell arrangement with at least one fuel cell stack, which comprises a first terminal plate, a second terminal plate, and numerous fuel cells, each comprising one anode and one cathode and an electrolyte arranged between the anode and the cathode, with the fuel cells being arranged along the longitudinal axis of the fuel cell stack between the first and the second terminal plate, a support structure in which the fuel cell stack is arranged, with the first terminal plate of the fuel cell stack being connected fixed to the support structure, if applicable, with the fuel cell arrangement according to the invention being characterized in that at least one bearing means is provided, different from the first terminal plate and perhaps connected fixed to the support structure, in order to compensate lateral forces impacting the fuel cell stack perpendicular in reference to the longitudinal axis of the stack.

According to the invention it is therefore suggested that when the first terminal plate is fixated to a support structure at least one additional bearing means is provided to compensate lateral forces impacting the fuel cell stack perpendicular in reference to the longitudinal axis extending in the direction of the stack. In case none of the terminal plates is fixated at the support structure, it is suggested according to the invention that at least one bearing means not representing a terminal plate is provided to compensate such lateral forces. The orientation of the fuel cell stack according to the invention is not subject to any restrictions, thus for example it can be vertical, preferably, however, horizontal. An orientation perpendicular to lateral forces acting in reference to the longitudinal axis of the stack and thus also the orientation of the bearing means provided to compensate these forces is not subject to any restrictions, either. In a horizontal orientation of the stack the respective bearing means may extend for example parallel (or anti-parallel) in reference to the direction of gravity or perpendicular in reference to the direction of gravity.

The support structure may represent a frame entirely or partially surrounding the fuel cell stack, which frame in turn may be surrounded by a housing. However, the support structure can also be formed by the housing itself surrounding the fuel cell stack.

Preferably the bearing means comprise at least one fastening plate arranged in the fuel cell stack, which is connected via a lateral bearing to the support structure. Here, a fastening plate arranged in the fuel cell stack is understood within the scope of the present invention as any fastening plate which is a part of the fuel cell stack, including the two terminal plates. In the present context a lateral bearing is understood as a bearing perpendicular in reference to the longitudinal axis of the fuel cell stack.

In case the first terminal plate is connected fixed to the support structure, as known from prior art, in a first variant of the fuel cell arrangement according to the invention at least one fastening plate may represent the second terminal plate limiting the fuel cell stack. In this variant the first terminal plate is connected via a fixed bearing to the support structure, while the second terminal plate, which forms the fastening plate to compensate lateral forces, is connected via a movable bearing to the support structure, so that the second terminal plate is mobile in the longitudinal direction of the stack, however fixed perpendicular in reference thereto. This way, deformations of the fuel cell stack between the two terminal plates are allowed, but simultaneously any lateral forces developing are compensated not only by the first terminal plate but also by the second terminal plate.

According to a second variant of the fuel cell arrangement according to the invention the fastening plate represents an intermediate plate arranged between two fuel cells of the fuel cell stack, which in turn is connected to the support structure in order to compensate lateral forces. According to one variant the intermediate plate arranged between two fuel cells represents the only support means to compensate lateral forces impacting the fuel cell stack perpendicular in reference to the longitudinal axis of the stack. In this case the two terminal plates of the fuel cell stack are freely mobile, except for their horizontal bearing or the vertical bearing of the first terminal plate. However, in reference to prior art, external lateral forces may also be introduced better into the support structure via the intermediate plate, because lateral forces no longer need to be transmitted over the entire length of the stack onto the support plate but respectively only along the portions of the stack located at both sides of the fastening plate. Therefore, preferably the intermediate plate is arranged essentially at midway of the length of the fuel cell stack. It is also possible to provide more than one intermediate plate, for example two intermediate plates, which then are arranged at one third and/or two thirds of the length of the stack.

In addition to the intermediate plate and/or the intermediate plates one or both terminal plates may also be embodied as fastening plates to compensate lateral forces.

The two terminal plates may for example be embodied as fixed bearings and/or movable bearings. In this case, any fixation of the intermediate plate perpendicular in reference to the longitudinal axis of the stack would lead to a statically undetermined bearing. Accordingly the lateral bearing for the intermediate plate is preferably embodied such that the intermediate plate is elastically connected to the support structure perpendicular in reference to the longitudinal axis of the stack.

According to one variant the intermediate plate can additionally be connected via a longitudinal bearing to the support structure. Preferably, in this case the intermediate plate is supported pivotal in the direction of the longitudinal axis of the fuel cell stack.

In larger fuel cell stacks, in addition to the intermediate plate, at least the second terminal plate is embodied as a mobile fastening plate connected via a lateral bearing to the support structure and elastic in the longitudinal axis of the fuel cell stack.

When at least three fastening plates are arranged in the fuel cell stack at least one of the fastening plates is arranged perpendicular in reference to the longitudinal axis of the stack. In order to achieve a statically determined bearing here the respective bearing means may be coupled to each other such that a compensation of the lateral forces is possible via the bearing means. For this purpose the bearing means may be connected to each other, for example, via a differential.

The lateral bearing engaging the fastening plate may represent a pendulum support, for example. In case of a horizontal fuel cell stack the pendulum support may, for example, also be arranged horizontally and connect the fastening plate to a lateral wall of the support structure and/or the housing.

According to another embodiment the lateral bearing comprises at least one passive adjustment cylinder. The adjustment cylinder may represent for example a passive servo jack for tensile forces and pressures, in which the side of the tensile force and the pressure side are connected such that compensating motions occur only very slowly. For example the side of the tensile force and the pressure side may be connected via a throttle valve. This way, briefly occurring external forces remain blocked, while forces impacting over an extended period are permitted. This way, for example ship movements can be blocked as a typical example of briefly occurring external forces, while the stack motion is permitted due to internal forces developing inside the stack caused by extended operation. According to a preferred embodiment of the adjustment cylinder here safety controls may be provided, which block the cylinder in critical operating conditions. A technical safety blocking of the cylinder can occur for example when a defined force is exceeded by a force-controlled shut-off valve. Further, the blocking valve can be closed via a tilt sensor when a defined angle of inclination has been exceeded. Additionally, a blocking of the cylinder can be triggered when a predetermined temperature is exceeded, which is determined via temperature sensors.

The bearing means preferably comprise isolation means, in order to isolate the fuel cell stack from the support structure at least electrically. In high-temperature fuel cells, such as molten carbonate fuel cells, the isolation means preferably also ensure the thermal insulation of the fuel cell stack from the support structure.

As known from prior art, preferably the first and the second terminal plate are elastically pre-stressed in reference to each other. According to a preferred variant here means for a controllable force are provided, which apply an essentially constant pre-tension upon the fuel cells arranged between the terminal plates.

In the following the invention is explained in greater detail with reference to the exemplary embodiment shown in the attached drawings.

The drawings show:

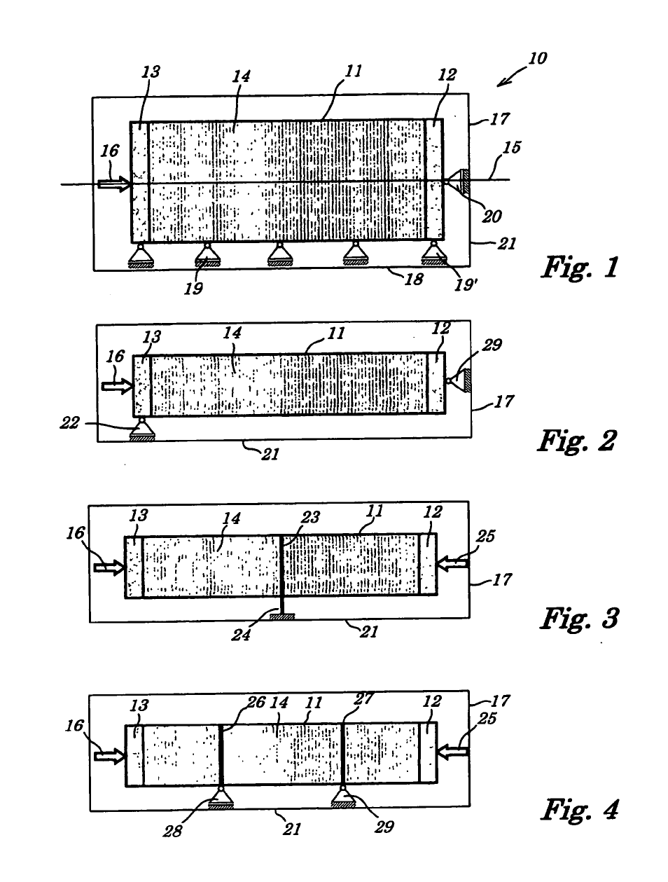

FIG. 1 a schematic side view of a horizontally arranged fuel cell stack;

FIG. 2 a schematic top view of a first embodiment of the fuel cell arrangement according to the invention, in which the second terminal plate is formed as an additional fastening plate;

FIG. 3 a schematic top view of a second embodiment of the fuel cell arrangement according to the invention, in which a fastening plate is arranged between the fuel cells of the stack;

FIG. 4 a schematic top view of a third embodiment of the fuel cell arrangement according to the invention, in which two fastening plates are arranged in the fuel cell stack;

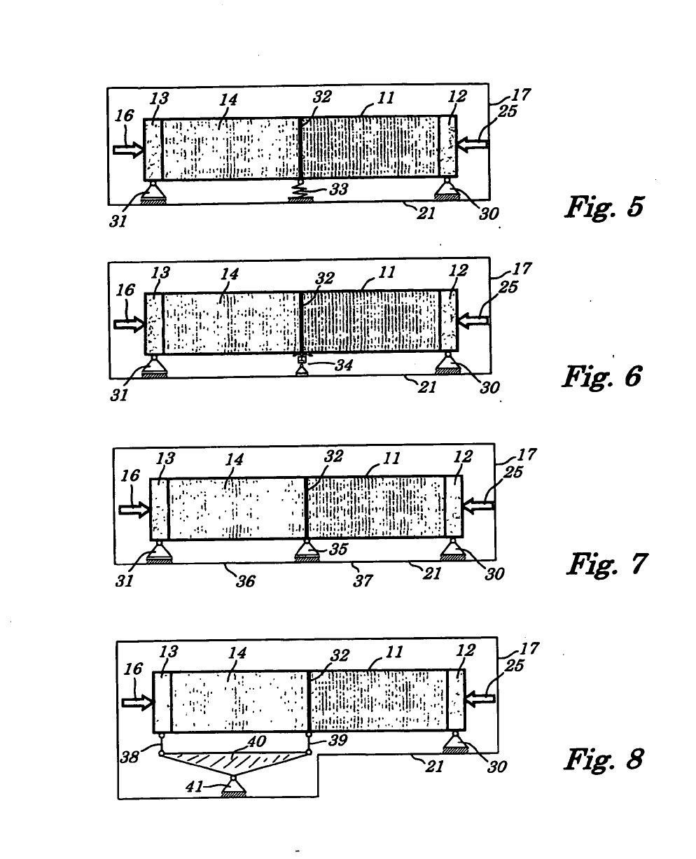

FIG. 5 a schematic top view of a fourth embodiment of the fuel cell arrangement according to the invention;

FIG. 6 a schematic top view of a variant of the fuel cell arrangement of FIG. 5;

FIG. 7 a schematic top view of another variant of the embodiment of FIG. 5;

FIG. 8 a schematic top view of a fifth embodiment of the fuel cell arrangement according to the invention;

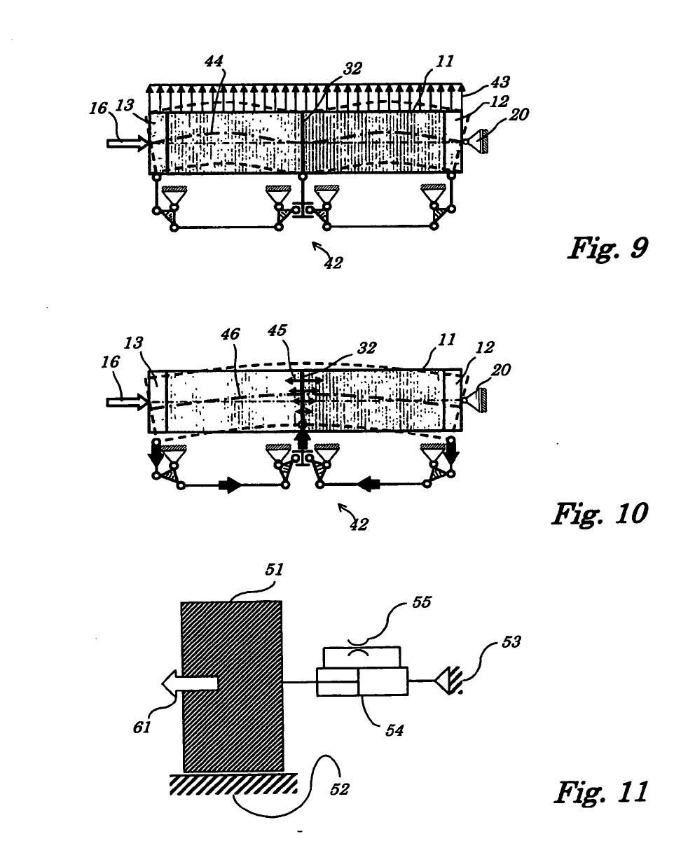

FIG. 9 a schematic top view of a variant of the embodiment of FIG. 8 when impacted by external forces;

FIG. 10 a schematic top view of the embodiment of FIG. 9 when impacted by internal forces;

FIG. 11 a schematic cross-section of a sixth embodiment of the fuel cell arrangement according to the invention, in which the lateral bearing comprises a passive adjustment cylinder;

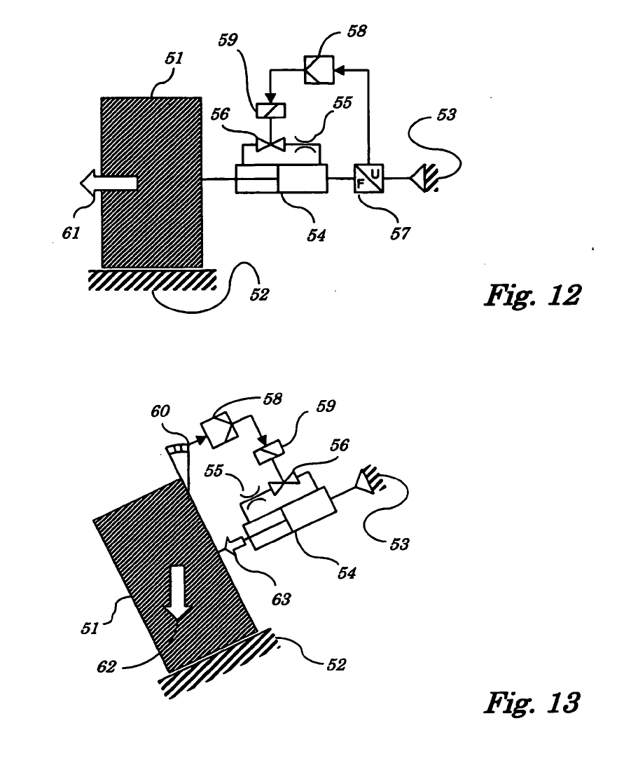

FIG. 12 a variant of the embodiment of FIG. 11 with a force-controlled shut-off valve; and

FIG. 13 a variant of the embodiment of FIG. 11 with an inclination-controlled shut-off valve.

FIG. 1 shows a side view of a fuel cell arrangement known per se and overall marked with the reference character 10, comprising a fuel cell stack 11 with a first terminal plate 12, a second terminal plate 13, and numerous fuel cells 14. Each of the fuel cells 14, not shown in greater detail in FIG. 1, comprises in a manner known per se one anode, one cathode, and electrolytes arranged between said anode and cathode. The fuel cells 14 are arranged along a longitudinal axis 15 of the fuel cell stack 11 between the first and the second terminal plate. The second terminal plate 13, opposite the first terminal plate 12, is pre-stressed in reference to said first terminal plate 12 (symbolized in FIG. 1 by the arrow 16 pointing to the terminal plate) and is mobile in the longitudinal direction of the stack within certain limits in order to compensate internal forces of the fuel cell stack, which for example develop due to temperature changes or chemical reactions. Further, a support structure 17 is schematically indicated, for example a housing surrounding the fuel cell stack, with on the one hand the fuel cell stack 11 resting thereon and being connected to the first terminal plate 12 of the stack 11. The support of the fuel cell stack 11 on the bottom 18 of the support structure 17 is symbolized in FIG. 1 by numerous mobile bearings 19. The first terminal plate 12 rests not only via a mobile bearing 19′ on the bottom 18 of the support structure 17 but is additionally connected via a mobile bearing 20, acting perpendicular in reference to the mobile bearing 19′, to a lateral wall 21 of the support structure 17. As an alternative to the two mobile bearings 19′ and 20, the first terminal plate 12 may also be connected via a fixed bearing (not shown here) to the support structure 17.

Usually, except for the fastening of the first terminal plate 12 described, no additional means are provided in order to compensate external forces, particularly lateral accelerations, thus forces impacting perpendicular in reference to the longitudinal axis 15 of the stack. The fuel cell arrangements of prior art designed for a higher performance range and thus comprising numerous fuel cells 14 arranged successively are therefore not suitable for mobile applications, for example, in which such external forces can occur during operation.

In order to allow such compensation of force it is now suggested according to the invention to provide at least one additional bearing means in the fuel cell stack 11 to compensate lateral forces acting upon the fuel cell stack 11 perpendicular in reference to the longitudinal axis 15 of the stack. For this purpose preferably at least one fastening plate is arranged in the fuel cell stack 11, which is connected by a lateral bearing to the support structure 17. In the following the concept suggested by the invention is explained in greater detail based on several exemplary embodiments.

The embodiments of the invention shown in FIG. 2 are based on the fuel cell arrangement 10 shown in FIG. 1, in which the first terminal plate 12 is connected to the support structure 17, for example via two mobile bearings 19′, 20 acting perpendicular in reference to each other, a fixed clamping, or via a fixed bearing 29. According to the invention it is suggested that when the first terminal plate is fixated at the support structure at least one additional bearing means is provided to compensate lateral forces acting upon the fuel cell stack perpendicular in reference to the longitudinal axis extending in the direction of the stack. FIG. 2 shows a first variant according to the invention in a schematic top view of the fuel cell stack 11. In this variant the fastening plate of an additional bearing means is formed by the second terminal plate 13. For this purpose, the second terminal plate 13 is connected via a lateral bearing 22, aligned perpendicular in reference to the mobile bearings 19, 19′ (not discernible in the top view of FIG. 2), to the lateral wall 21 of the support structure 17. When the first terminal plate is connected via two mobile bearings acting perpendicular in reference to each other or via a fixed bearing to the support structure 17 the lateral bearing 22, as shown, is embodied as a mobile bearing. Of course, alternatively the second terminal plate 13 may also be connected via a fixed bearing and the first terminal plate 12 via a mobile bearing to the support structure 17 so that the second terminal plate is mobile in the longitudinal direction of the stack but fixed perpendicularly thereto. In this embodiment deformations of the fuel cell stack 11 between the two terminal plates 12, 13 are allowed, however simultaneously any lateral forces developing are not only compensated by the first terminal plate 12 but also by the second terminal plate 13.

In case none of the terminal plates 12, 13 are fixated at the support structure 17 it is suggested according to the invention that at least one intermediate plate is provided in the fuel cell stack 11 to compensate lateral forces.

In the top view of a second embodiment of the fuel cell arrangement 11 according to the invention shown schematically in FIG. 3 the suggested lateral bearing does not engage at the second terminal plate 13, contrary to the variant of FIG. 2. Rather, in the variant of FIG. 3 a fastening plate is provided as an intermediate plate 23, which is arranged in the stack 11 between two fuel cells 14. The intermediate plate 23 is connected via a lateral bearing 24 to the support structure 17. In this case, the lateral bearing 24 is preferably embodied as a fixed clamping. In this case, neither the first nor the second terminal plate 12, 13 serves to compensate lateral forces, but the two terminal plates 12, 13 are only pre-stressed in reference to each other, which is symbolized by the arrows 16, 25 in FIG. 3. Preferably the intermediate plate 23 represents a plate particularly designed to compensate lateral forces. However, the intermediate plate 23 can also assume additional functions, for example cooling functions, and for this purpose be provided with channels for a liquid coolant, for example. According to another variant the intermediate plate may also be a fuel cell embodied particularly strong mechanically. According to this variant the intermediate plate 23 arranged between the two fuel cells 14 represents the only bearing means to compensate lateral forces impacting the fuel cell stack 11 perpendicular in reference to the longitudinal axis of the stack. In this case the two terminal plates 12, 13 of the fuel cell stack 11 are freely mobile, except for their horizontal bearing or the vertical bearing of the first terminal plate 13. However, in reference to prior art external lateral forces can also be introduced better into the support structure 17, due to the intermediate plate 23, because lateral forces no longer need to be transferred over the entire length of the stack to the fastening plate 23 but only along the portions of the stack 11 respectively at the two sides of the fastening plate 23. Preferably the intermediate plate 23 is therefore arranged essentially half way along the fuel cell stack 11.

According to one variant (not shown) of the embodiment of FIG. 3 the first or second terminal plate (such as for example the first terminal plate of FIG. 3) may be connected to the support structure. In this case the lateral bearing 24 is preferably embodied as a mobile bearing.

FIG. 4 shows here a schematic top view of a third embodiment of the fuel cell arrangement according to the invention, in which the first and second terminal plate 12, 13, as in the case of FIG. 3, are not connected to the support structure 17 but are only pre-stressed in reference to each other (arrows 16, 25). As the embodiment illustrated in FIG. 4 shows, it is also possible to provide more than one intermediate plate, for example two intermediate plates 26, 27 connected via lateral bearings to the support structure 17, which are then arranged for example at one third and/or two thirds of the length of the stack. In the example shown the intermediate plate 26 is connected via a mobile bearing 28 and the intermediate plate 27 is connected via a fixed bearing 29 to the lateral wall 21 of the support structure.

In the exemplary embodiments of FIGS. 2 to 4 the fuel cell stack 11 is determined by maximally two fastening plates perpendicular in reference to the longitudinal axis 15 of the stack. In these cases the bearing of the stack is statically determined. The size of the fuel cell stack and/or the strength of the impinging external forces may require fastening the fuel cell stack in the lateral direction by more than two fastening plates. However, if more than two fastening plates are connected via the lateral bearing, embodied as a fixed bearing and/or mobile bearing, to the lateral wall of the support structure, this leads to a statically undetermined lateral bearing of the stack. In such cases it is suggested according to the invention to reduce the statically undetermined bearing via an elastic foundation of one or more fastening plates or via a differential to a statically determined bearing. In the following, respective embodiments of the invention are explained with reference to FIGS. 5 to 10.

In the top view of a fourth embodiment of the invention shown in FIG. 5 three fastening plates are connected via lateral bearings to the support structure 11. On the one hand, the first terminal plate 12 is connected via a fixed bearing 30 to the lateral wall 21 of the support structure 11, while the second terminal plate 13 is connected via a mobile lateral bearing 31 to the side wall. An intermediate plate 32 arranged in the stack is connected to the side wall via an elastic lateral bearing 33. According to a variant not shown the intermediate plate 32 may additionally be connected via a longitudinal bearing to the support structure. Preferably in this case the intermediate plate 32 is supported pivotal in the direction of the longitudinal axis 15 of the fuel cell stack 11. In larger fuel cell stacks, in addition to an intermediate plate, at least the second terminal plate 13 is embodied as a mobile fastening plate elastic in the longitudinal axis 15 of the fuel cell stack 11 and connected via a lateral bearing to the support structure.

FIG. 6 shows a variant of the embodiment of FIG. 5, with the intermediate plate 32 being connected, instead of via a spring, via a damping element 34 to the lateral wall 21 of the support structure 11, as indicated by arrows, allowing a displacement in the longitudinal direction of the stack.

FIG. 7 shows another variant of the embodiment shown in FIG. 5. In this case the intermediate plate 32 is connected fixed via a lateral bearing 35 to the lateral wall 21 of the support structure 11. In this case, the elastic foundation is ensured by the elasticity of the wall sections 36, 37 of the lateral wall 21 of the support structure 17 connecting the lateral bearings 30, 31, 35. The lateral bearings 31, 32 may represent mobile bearings or stiff lateral joints, as indicated.

When at least three fastening plates are arranged in the fuel cell stack at least one of the fastening plates will be mobile perpendicular in reference to the longitudinal axis of the stack. In order to achieve a statically determined bearing here the respective bearing means can be coupled to each other such that a compensation of lateral forces accepted by the bearing means is possible. For this purpose, the bearing means may be connected to each other, for example via a compensation joint or a differential.

FIG. 8 shows an embodiment with a compensating joint. The intermediate plate 32 and the second terminal plate 13 are connected via joining rods 38, 39 and a stiff compensation plate 40 to the lateral bearing 41 embodied as a fixed bearing such that their position in reference to each other is not altered when any external forces impacting the stack are evenly distributed.

One variant of the embodiment of FIG. 8, with the differential in its entirety marked with the reference character 42, is shown in FIGS. 9 and 10. FIG. 9 shows the reaction of the fuel cell stack 11 to evenly distributed external forces (arrows 43). The stack may deform (dot-dash lines 44) by the differential 42, however the support remains balanced. FIG. 10 shows the effect of the differential 42 when internal forces develop, for example due to a temperature profile in the lateral direction caused by chemical reactions. Different expansions of the cell areas of the fuel cells in the stack in the lateral direction (arrows 45) lead to a curvature of the stack 11 (dot-dash lines 46), however the transmission can compensate this deformation of the stack.

The lateral bearings described in the various embodiments may represent a pendulum support, for example, which are perhaps also provided with a suitable electric and/or thermal insulation in order to isolate the fuel cell stack 11 from the support structure 17.

However, FIG. 11 shows a variant of the fuel cell stack according to the invention in which at least one lateral bearing comprises a passive adjustment cylinder, for example a hydraulic cylinder. In FIG. 11 the fuel cell stack is marked with the reference character 11, with the cross-section being located at a point along the longitudinal axis of the stack which is not held fixed perpendicular in reference to the axis of the stack (cf. embodiments of FIGS. 1-10). The reference character 52 marks a mobile hearing of the stack, while the reference character 53 marks a fixed bearing. A dual-purpose servo jack 54 serves as a lateral bearing and connects the stack 51 to the fixed bearing 53. In an overflow channel a throttle valve 55 is provided between the pressurized cylinder chamber of the servo jack 54 and the side subject to tensile forces, so that rapid movements of the stack due to weight forces in the lateral direction of the stack are slowed down. Slow movements of the stack due to internal forces are permitted, though.

FIG. 12 shows a variant of the arrangement of FIG. 11, with elements, already described in the context of the embodiment of FIG. 11, being marked with the same reference characters and not explained here. In the variant of FIG. 12 additionally a force-controlled shut-off valve 56 is provided in the overflow channel between the cylinder chambers of the servo jack 54, which blocks the servo jack 54 when a predefined force is exceeded. For this purpose a force measuring unit 57 is arranged between the servo jack 54 and the fixed bearing 53, which controls an actuator 59 via a control 58, which actuator blocks the shut-off valve 56 when a predetermined force is exceeded.

In the variant of FIG. 13 once more a shut-off valve 56 is provided in the overflow channel between the cylinder chambers of the servo jack 54, which similar to the variant of FIG. 12 is operated via a control 58 and an actuator 59. In any case, the signal of an angular transmitter 60 acts upon the control 58 so that the shut-off valve 56 is closed when a predefined inclination is exceeded.

In FIGS. 11-13 the respectively acting forces are marked by arrows: Thus in FIGS. 11 and 12 the arrow 61 indicates the weight force perpendicular in reference to the axis of the stack, while the arrow 62 in FIG. 13 symbolizes the weight of the stack. The arrow 63 marks the component of a weight force impacting perpendicular in reference to the longitudinal axis of the stack.

1. A fuel cell arrangement with
at least one fuel cell stack comprising a first terminal plate, a second terminal plate, and numerous fuel cells, each showing an anode, a cathode, and an electrolyte arranged between the anode and the cathode, with the fuel cells being arranged along a longitudinal axis of the fuel cell stack between the first and the second terminal plate,
a support structure in which the fuel cells stack is arranged, with the first terminal plate of the fuel cell stacks perhaps being connected fixed to the support structure, characterized in that
at least one first terminal plate, perhaps connected fixed to the support structure, is provided to compensate lateral forces impacting the fuel cell stack perpendicular in reference to the longitudinal axis of the stack.

2. A fuel cell arrangement according to claim 1, characterized in that the bearing means comprise at least one fastening plate arranged in the fuel cell stack which is connected via a lateral bearing to the support structure.

3. A fuel cell arrangement according to claim 2, with the first terminal plate being connected fixed to the support structure, characterized in that at least one fastening plate represents the second terminal plate limiting the fuel cell stack.

4. A fuel cell arrangement according to claim 3, characterized in that the lateral bearing fixates the fastening plate in a direction oriented perpendicular to the longitudinal direction of the stack.

5. A fuel cell arrangement according to claim 2, characterized in that the fastening plate is an intermediate plate arranged between two fuel cells of the fuel cell stacks.

6. A fuel cell arrangement according to claim 5, characterized in that the intermediate plate is arranged essentially halfway along the fuel cell stack.

7. A fuel cell arrangement according to claim 5, characterized in that the lateral bearing elastically connects the intermediate plate to the support structure, perpendicular in reference to the longitudinal axis of the stack.

8. A fuel cell arrangement according to claim 5, characterized in that the intermediate plate is additionally connected via a longitudinal bearing to the support structure.

9. A fuel cell arrangement according to claim 8, characterized in that the intermediate plate is supported pivotal in the direction of the longitudinal axis of the fuel cell stack.

10. A fuel cell arrangement according to claim 5, with additionally at least the second terminal plate being embodied as a mobile fastening plate connected via a lateral bearing to the support structure, elastic in the longitudinal axis of the fuel cell stack.

11. A fuel cell arrangement according to claim 5, characterized in that at least three fastening plates are arranged in the fuel cell stack, with her at least one fastening plate being mobile perpendicular in reference to the longitudinal axis of the stack, with the bearing means allocated to the fastening plates being coupled to each other such that they allow a compensation of lateral forces accepted by the bearing means.

12. A fuel cell arrangement according to claim 11, characterized in that the bearing means are connected to each other via a differential.

13. A fuel cell arrangement according to claim 2, characterized in that the lateral bearing comprises an essentially horizontally arranged pendulum support.

14. A fuel cell arrangement according to claim 2, characterized in that the lateral bearing comprises a passive adjustment cylinder.

15. A fuel cell arrangement according to claim 1, characterized in that the bearing means comprise isolation means in order to isolate the fuel cell stack at least electrically, preferably also thermally from the support structure.

16. A fuel cell arrangement according to claim 1, characterized in that the first and second terminal plate cooperate with controlled force means such that an essentially constant pre-stressing is applied upon the fuel cells arranged between the terminal plates.
